(19) United States
(12) Patent Application Publication
(10) Pub. No.: US 2025/0232190 A1
(43) Pub. Date: Jul. 17, 2025

(54) LARGE SCALE GENERATIVE ARTIFICIAL INTELLIGENCE FOR GENERATION OF CUSTOMIZED CONTENT

(71) Applicant: INTERNATIONAL BUSINESS MACHINES CORPORATION, Armonk, NY (US)

(72) Inventors: Aaron K. Baughman, Cary, NC (US); Gozde Akay, Fredericton (CA); Rahul Agarwal, Jersey City, NJ (US); Leonid Karlinsky, Acton, MA (US)

(21) Appl. No.: 18/413,927

(22) Filed: Jan. 16, 2024

(51) Int. Cl. G06N 5/02; G06N 3/0985

(52) U.S. Cl. CPC G06N 5/02; G06N 3/0985

(57) ABSTRACT

A request for a customized reply is received from a requester. One or more templates stored in a selected location are retrieved based, at least in part, on at least one ontology constructed for one or more domains associated with the request for the customized reply. Information relating to the requester is input into the one or more templates to provide one or more populated templates. The customized reply to the request is generated based on the one or more populated templates and provided to the requester.

### BACKGROUND

One or more aspects relate, in general, to processing within a computing environment, and in particular, to facilitating such processing.

Processing within a computing environment is performed for many tasks, including responding to requests for information. The information may be related to many events, including, but not limited to, the processing within the computing environment, manufacturing, technology events, information technology events, industry-specific events, physical activity events, any events that produce and/or have associated therewith large amounts of data, including statistical data, etc. As an example, the information returned is based on a vast amount of data, including real-time data, that is to be collected, digested, interpreted and/or condensed to output the relevant information based on the request and event. To facilitate this processing, large language models (LLMs) are used.

A large language model is a deep learning algorithm that can perform various natural language processing (NLP) tasks. Large language models use transformer models and are trained using very large (e.g., massive) datasets. This enables them to recognize, translate, predict and/or generate text and/or other content. Large language models are a subset of generative artificial intelligence (AI), which is artificial intelligence capable of generating text, images and/or other media, using generative models. Generative AI models learn the patterns and structure of their input training data and then use inferencing to generate new data that has similar characteristics. Large language models may be combined with diffusion models or generative adversarial networks (GANs) to produce multimedia content. A generative adversarial network is a class of machine learning framework providing a framework for approaching generative artificial intelligence (AI).

Currently, large language models are shielded with rate limiters (e.g., limit on the number of requests that can be processed) and/or are supported by large numbers of graphics processing unit (GPU) based machines.

### SUMMARY

Shortcomings of the prior art are overcome, and additional advantages are provided through the provision of a computer-implemented method of facilitating processing within a computing environment. In one aspect, the computer-implemented method includes receiving from a requester a request for a customized reply. The receiving the request uses one or more networks of the computing environment. One or more templates stored in a selected location are retrieved based, at least in part, on at least one ontology constructed for one or more domains associated with the request for the customized reply. Information related to the requester is input into the one or more templates to provide one or more populated templates. The customized reply to the request is generated based on the one or more populated templates, and the customized reply is provided to the requester.

In one or more aspects, a computer-implemented method of facilitating processing within a computing environment is provided. The computer-implemented method includes receiving from a requester a request over one or more networks of the computing environment. The request is related to a selected event. One or more templates stored in a selected location are retrieved. The one or more templates are retrieved based, at least in part, on one or more ontologies constructed for the selected event. The one or more templates are created using a large language model trained to create the one or more templates based on the selected event and the large language model is shielded from direct request traffic. Information is input in the one or more templates to provide one or more populated templates. A customized reply to the request is generated based on the one or more populated templates. The customized reply that is generated based on the one or more populated templates is provided to the requester.

Computer-implemented methods, computer systems and computer program products relating to one or more aspects are described and claimed herein. Each of the embodiments of each computer-implemented method may be embodiments of each computer system and/or each computer program product and vice-versa. Each of the embodiments of each computer-implemented method may be combinable with aspects and/or embodiments of each computer system and/or computer program product, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 depicts one example of a large language model architecture used in accordance with one or more aspects of the present disclosure;

FIG. 3A depicts one example of sub-modules of an artificial intelligence (AI) request/reply module of FIG. 1, in accordance with one or more aspects of the present disclosure;

FIG. 3B depicts one example of a templates creation sub-module of the AI request/reply module of FIG. 3A, in accordance with one or more aspects of the present disclosure;

FIG. 3C depicts one example of a train/tune large language model(s) sub-module of the templates creation sub-module of FIG. 3B, in accordance with one or more aspects of the present disclosure;

FIG. 3D depicts one example of a customize fill-in of created templates sub-module of the AI request/reply module of FIG. 3A, in accordance with one or more aspects of the present disclosure;

FIG. 4 depicts one example of an artificial intelligence request/reply process, in accordance with one or more aspects of the present disclosure;

FIG. 5 depicts one example of a training/tuning architecture used in accordance with one or more aspects of the present disclosure;

FIGS. 6A-6B depict examples of training pairs used in accordance with one or more aspects of the present disclosure;

FIG. 7 depicts one example of a reinforcement process used in accordance with one or more aspects of the present disclosure;

FIG. 8 depicts one example of a machine learning training system used in accordance with one or more aspects of the present disclosure; and

FIG. 9 depicts one example of artificial intelligence generated information, in accordance with one or more aspects of the present disclosure.

### DETAILED DESCRIPTION

In one or more aspects, a capability is provided to facilitate processing within a computing environment. The capability includes, for instance, a technique to provide customized replies to requests for information received over network(s) of the computing environment within a selected amount of time. In one example, many requests, even thousands (e.g., 2,000-3000 requests; other numbers of requests) may be received within a predefined amount of time (e.g., per second or other predefined amount of time) and the capability streamlines processing such that customized replies or responses are provided within the selected amount of time.

In one or more aspects, the capability includes a bifurcated technique in which one part of a request/reply process receives requests, generates customized replies to the requests and provides the customized replies; and another part of the request/reply process creates templates (e.g., artificial intelligence templates) to be used to generate the customized replies and stores the templates for access by the one part of the request/reply process. By bifurcating the process, the other part of the process used to create the templates is shielded from the incoming requests enabling the templates to be created and stored using a reduced set of computing resources (e.g., one or two graphics processing units) instead of many more computing resources (e.g., over 800 graphics processing units) if the shielding did not exist. For instance, to create the templates, one or more large language models are used and trained with the reduced set of computing resources. The created templates are stored in a location (e.g., cache) accessible to the one part of the process. This facilitates processing within the computing environment by providing templates that are accessible and scalable—may be changed by re-training and/or customizing during template creation—using significantly fewer computing resources.

As indicated, in accordance with one or more aspects, large language models are used to create templates, which are then retrieved and used to generate customized replies. Previously, large language models have been created to interpret specific events. For instance, for a selected event, a set of transformers converted statistics regarding the selected event (e.g., relating to participants of the selected event and/or specific occurrences within/relating to the selected event) to text and then paraphrased the text to be provided as output. Further, the text may have been translated from text to speech. Those large language models, however, are shielded with rate limiters and/or are supported by large numbers of graphics processing unit (GPU) based machines.

The application of generative artificial intelligence techniques within very high web traffic events, as defined, e.g., as more than 100 requests per second, is limited. For instance, to sustain a chosen response time of, e.g., 1-3 seconds, for a particular selected event, an inference system may use hundreds (e.g., over 800) parallel graphics processing units. Further, the amount of memory of a graphics processing unit used to load and train large language models is related to the model parameter size. Thus, a large amount of memory may be used in the loading and training of large language models.

In accordance with one or more aspects of the present disclosure, customized replies for requests received over one or more networks (e.g., the web) are generated and provided to the requesters in a manner that minimizes the amount of computing resources. For instance, large language models used to create templates which are then used to generate customized replies are trained using a reduced set of graphics processing units (e.g., may only use one or two graphics processing units to train instead of over 800 graphics processing units; other examples are possible).

In one aspect, a computer-implemented method of facilitating processing within a computing environment is provided. The computer-implemented method includes receiving from a requester a request for a customized reply. The receiving the request uses one or more networks of the computing environment. One or more templates stored in a selected location are retrieved based, at least in part, on at least one ontology constructed for one or more domains associated with the request for the customized reply. Information relating to the requster is input into the one or more templates to provide one or more populated templates. The customized reply to the request is generated based on the one or more populated templates, and the customized reply is provided to the requester.

By using templates to generate a customized reply, processing is facilitated by shielding the large language model(s) used to create the templates from the incoming requests, enabling the large language model(s) to be trained and create the templates using a reduced set of computing resources.

Additionally, or alternatively, in one or more embodiments, the information relating to the requester is obtained from one or more requester data sources corresponding to the request. Further, additionally, or alternatively, one or more external data sources are queried to construct one or more ontologies for the one or more domains associated with the request for the customized reply.

Additionally, or alternatively, in one or more embodiments, the one or more templates are one or more artificial intelligence templates. By using artificial intelligence templates, the templates may be updated using less data, saving on computing resources, including memory.

Additionally, or alternatively, in one or more embodiments, the one or more templates are created using a large language model that is tuned to isolate one or more chosen parts of the large language model and to prune one or more other parts from the large language model that are not chosen. This tuning saves on computing resources used to tune, providing efficiencies within the computing environment.

Additionally, or alternatively, in one or more embodiments, the retrieving the one or more templates includes using a key generated based on a prompt of the request to select for retrieval at least one template of the one or more templates stored in the selected location. By saving the templates in a selected location and retrieving a template based on a key, access to the templates is facilitated and performance within the computing environment is improved. By creating and saving the templates prior to using the templates, performance is improved by bifurcating the process of creating the templates and using the templates, which shields the large language models used in creating the templates from the requesters.

Additionally, or alternatively, in one or more embodiments, the computer-implemented method further includes receiving requester feedback regarding the customized reply provided to the requester and modifying one or more weights of the one or more templates based on the requester feedback. The one or more weights are modified based on performing reinforcement learning context generation. This facilitates creation of replies acceptable to the requester. It further enables creation of acceptable replies within given time constraints using technological facilities of the computing environment.

Additionally, or alternatively, in one or more embodiments, the computer-implemented method includes performing retrieval augmented generation to establish one or more context vectors that provide supporting information for generation of the customized reply to the request and establishing the one or more context vectors. The establishing includes retrieving selected data from one or more external data sources. The selected data is knowledge data missing from a large language model used to create the one or more templates. The knowledge data is to be used to generate the customized reply. The selected data that is retrieved is combined with parametric data encoded by the large language model to establish the one or more context vectors. This facilitates automatic generation of templates to provide requester customized replies using a reduced set of computing resources. In one embodiment, the requester customized replies are automatically generated.

Additionally, or alternatively, in one or more embodiments, the parametric data includes one or more large language model weights and one or more fine-tuned weight adjustments. This facilitates the automatic generation of templates that are tuned for the requester.

Additionally, or alternatively, in one or more embodiments, the customized reply to the request is to be received within a predefined amount of time. Processing is performed that enables, using technological facilities, the customized reply to be received within the predefined amount of time.

Additionally, or alternatively, in one or more embodiments, the receiving the request includes receiving a plurality of requests for a plurality of customized replies at a particular request rate. The plurality of requests includes the request. Processing is performed that enables, using technological facilities, requests to be received and customized replies to be provided within acceptable time limits. This processing uses a reduced set of computing resources, at least, for the creation of templates used in replying to the received requests.

Additionally, or alternatively, in one or more embodiments, the one or more templates are generated using a large language model, in which the large language model is trained using a reduced set of computing resources.

In accordance with one or more aspects, each of the embodiments is separable and optional from one another. Further, embodiments may be combined with one another.

In one or more aspects, a computer system for facilitating processing within a computing environment is provided. The computer system includes a processor set, a set of at least one computer-readable storage medium, and program instructions, collectively stored in the set of at least one computer-readable storage medium for causing the processor set to perform the following computer operations including receive from a requester a request for a customized reply. The receiving the request uses one or more networks of the computing environment. One or more templates stored in a selected location are retrieved based, at least in part, on at least one ontology constructed for one or more domains associated with the request for the customized reply. Information relating to the requester is input into the one or more templates to provide one or more populated templates. The customized reply to the request is generated based on the one or more populated templates, and the customized reply is provided to the requester.

By using templates to generate a customized reply, processing is facilitated by shielding the large language model(s) used to create the templates from the incoming requests, enabling the large language model(s) to be trained and create the templates using a reduced set of computing resources.

Additionally, or alternatively, in one or more embodiments, the information relating to the requester is obtained from one or more requester data sources corresponding to the request. Further, additionally, or alternatively, one or more external data sources are queried to construct one or more ontologies for the one or more domains associated with the request for the customized reply.

Additionally, or alternatively, in one or more embodiments, the one or more templates are created using a large language model that is tuned to isolate one or more chosen parts of the large language model and to prune one or more other parts from the large language model that are not chosen. This tuning saves on computing resources used to tune, providing efficiencies within the computing environment.

Additionally, or alternatively, in one or more embodiments, the retrieving the one or more templates includes using a key generated based on a prompt of the request to select for retrieval at least one template of the one or more templates stored in the selected location. By saving the templates in a selected location and retrieving a template based on a key, access to the templates is facilitated and performance within the computing environment is improved. By creating and saving the templates prior to using the templates, performance is improved by bifurcating the process of creating the templates and using the templates, which shields the large language models used in creating the templates from the requesters.

Additionally, or alternatively, in one or more embodiments, requester feedback regarding the customized reply provided to the requester is received, and one or more weights of the one or more templates are modified based on the requester feedback. The one or more weights are modified based on performing reinforcement learning context generation. This facilitates creation of replies acceptable to the requester. It further enables creation of acceptable replies within given time constraints using technological facilities of the computing environment.

Additionally, or alternatively, in one or more embodiments, the receiving the request includes receiving a plurality of requests for a plurality of customized replies at a particular request rate. The plurality of requests includes the request. Processing is performed that enables, using technological facilities, requests to be received and customized replies to be provided within acceptable time limits. This processing uses a reduced set of computing resources, at least, for the creation of templates used in replying to the received requests.

In accordance with one or more aspects, each of the embodiments is separable and optional from one another. Further, embodiments may be combined with one another.

In one or more aspects, a computer program product for facilitating processing within a computing environment is provided. The computer program product includes a set of at least one computer-readable storage medium, and program instructions, collectively stored in the set of at least one computer-readable storage medium for causing the processor set to perform the following computer operations including receive from a requester a request for a customized reply. The receiving the request uses one or more networks of the computing environment. One or more templates stored in a selected location are retrieved based, at least in part, on at least one ontology constructed for one or more domains associated with the request for the customized reply. Information relating to the requester is input into the one or more templates to provide one or more populated templates. The customized reply to the request is generated based on the one or more populated templates, and the customized reply is provided to the requester.

By using templates to generate a customized reply, processing is facilitated by shielding the large language model(s) used to create the templates from the incoming requests, enabling the large language model(s) to be trained and create the templates using a reduced set of computing resources.

Additionally, or alternatively, in one or more embodiments, the information relating to the requester is obtained from one or more requester data sources corresponding to the request. Further, additionally, or alternatively, one or more external data sources are queried to construct one or more ontologies for the one or more domains associated with the request for the customized reply.

Additionally, or alternatively, in one or more embodiments, the one or more templates are created using a large language model that is tuned to isolate one or more chosen parts of the large language model and to prune one or more other parts from the large language model that are not chosen. This tuning saves on computing resources used to tune, providing efficiencies within the computing environment.

Additionally, or alternatively, in one or more embodiments, the retrieving the one or more templates includes using a key generated based on a prompt of the request to select for retrieval at least one template of the one or more templates stored in the selected location. By saving the templates in a selected location and retrieving a template based on a key, access to the templates is facilitated and performance within the computing environment is improved. By creating and saving the templates prior to using the templates, performance is improved by bifurcating the process of creating the templates and using the templates, which shields the large language models used in creating the templates from the requesters.

Additionally, or alternatively, in one or more embodiments, requester feedback regarding the customized reply provided to the requester is received, and one or more weights of the one or more templates are modified based on the requester feedback. The one or more weights are modified based on performing reinforcement learning context generation. This facilitates creation of replies acceptable to the requester. It further enables creation of acceptable replies within given time constraints using technological facilities of the computing environment.

Additionally, or alternatively, in one or more embodiments, the receiving the request includes receiving a plurality of requests for a plurality of customized replies at a particular request rate. The plurality of requests includes the request. Processing is performed that enables, using technological facilities, requests to be received and customized replies to be provided within acceptable time limits. This processing uses a reduced set of computing resources, at least, for the creation of templates used in replying to the received requests.

In accordance with one or more aspects, each of the embodiments is separable and optional from one another. Further, embodiments may be combined with one another.

In one or more aspects, a computer-implemented method of facilitating processing within a computing environment is provided. The computer-implemented method includes receiving from a requester a request over one or more networks of the computing environment. The request is related to a selected event. One or more templates stored in a selected location are retrieved. The one or more templates are retrieved based, at least in part, on one or more ontologies constructed for the selected event. The one or more templates are created using a large language model trained to create the one or more templates based on the selected event and the large language model is shielded from direct request traffic. Information is input in the one or more templates to provide one or more populated templates. A customized reply to the request is generated based on the one or more populated templates. The customized reply that is generated based on the one or more populated templates is provided to the requester.

By using templates to generate a customized reply, processing is facilitated by shielding the large language model(s) used to create the templates from the incoming requests, enabling the large language model(s) to be trained and create the templates using a reduced set of computing resources.

Additionally, or alternatively, in one or more embodiments, the information is information that is obtained to be used to prepare the customized reply to the request.

Additionally, or alternatively, in one or more embodiments, the providing the customized reply is performed within a selected amount of time. Processing is performed that enables, using technological facilities, the customized reply to be received within the predefined amount of time.

Additionally, or alternatively, in one or more embodiments, the large language model is trained using a reduced set of computing resources.

Additionally, or alternatively, in one or more embodiments, the receiving the request includes receiving a plurality of requests for a plurality of customized replies at a particular request rate. The plurality of requests includes the request. Processing is performed that enables, using technological facilities, requests to be received and customized replies to be provided within acceptable time limits. This processing uses a reduced set of computing resources, at least, for the creation of templates used in replying to the received requests.

Additionally, or alternatively, in one or more embodiments, the large language model that is trained is tuned using one or more tuning techniques. The tuning enables the large language model to effectively produce results (e.g., generate templates) in a more efficient manner and be trained using a reduced set of resources.

In accordance with one or more aspects, each of the embodiments is separable and optional from one another. Further, embodiments may be combined with one another.

One or more aspects include computer-implemented methods, computer systems and computer program products. Each of the embodiments of each computer-implemented method may be embodiments of each computer system and/or each computer program product and vice-versa. Each of the embodiments of the computer-implemented method may be combinable with aspects and/or embodiments of each computer system and/or computer program product, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., creates templates (e.g., artificial intelligence templates), generates customized replies to requests using the created templates and/or performs one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

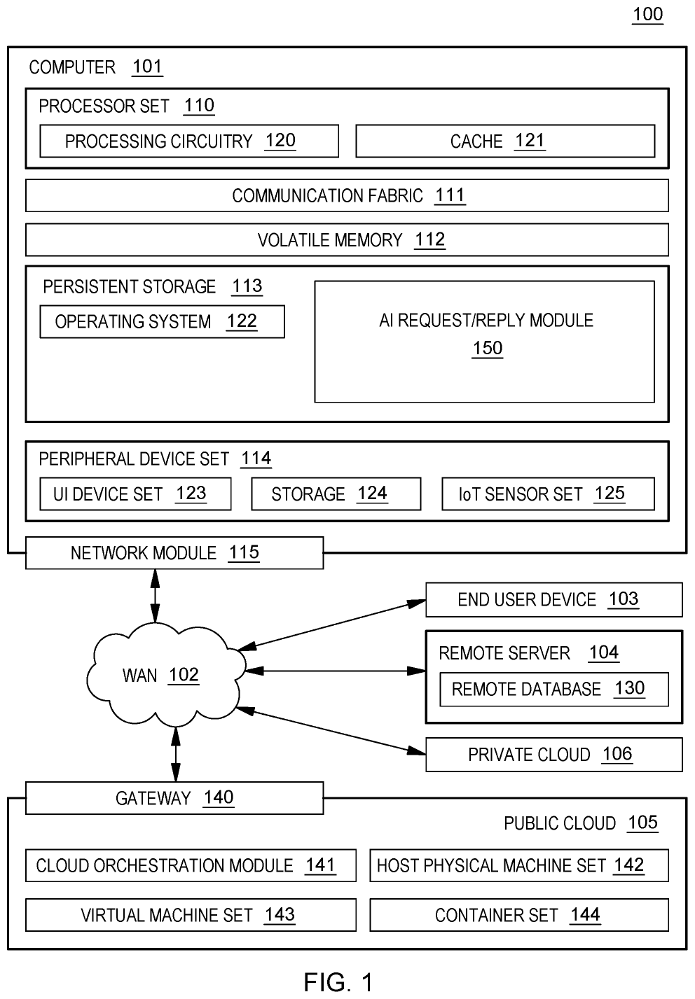

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as artificial intelligence (AI) request/reply code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

In one or more aspects, a capability is provided in which many requests (e.g., thousands of requests, such as, e.g., 2,000-3,000 requests; other number of requests) received within a predefined amount of time (e.g., per second or other defined amount of time) are replied to with customized replies within a selected amount of time (e.g., 3-4 seconds or other selected amounts of time). The capability includes a bifurcated technique in which one part of a request/reply process receives requests, generates customized replies to the requests and provides the customized replies; and another part of the request/reply process creates templates (e.g., artificial intelligence templates) to be used to generate the customized replies and stores the templates for access by the one part of the process. By bifurcating the process, the other part of the process used to create the templates is shielded from the incoming requests enabling the templates to be created and stored using a reduced set of computing resources (e.g., one or two graphics processing units; other numbers of graphics processing units) instead of many more computing resources (e.g., over 800 graphics processing units; other numbers of graphics processing units) if the shielding did not exist. For instance, to create the templates, one or more large language models are used and trained with the reduced set of computing resources. The created templates are stored in a location (e.g., cache) accessible to the one part of the process. This facilitates processing within the computing environment by providing templates that are accessible and scalable—may be changed by re-training and/or customizing during template creation—using significantly fewer computing resources.

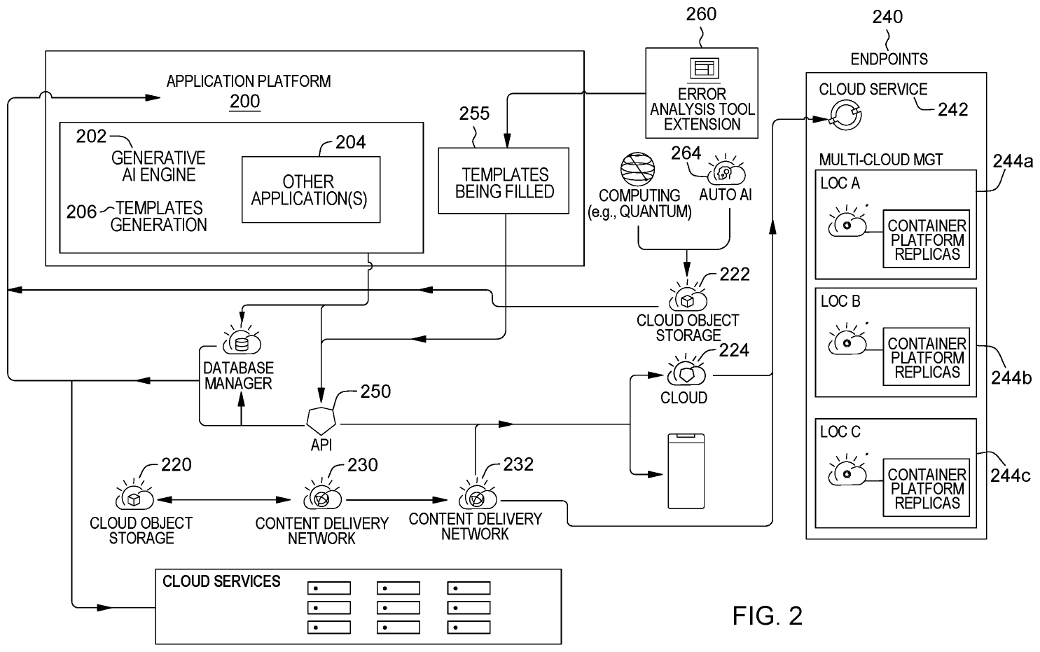

In one or more aspects, one or more large language models are used to provide customized content, such as customized replies to requests. The one or more large language models are shielded from the requests (e.g., direct consumer traffic flowing over one or more networks) by teaching the model how to compose templates that are retrievable by a consumer-facing application (e.g., an application receiving the requests). One example of a batched large language model architecture to create cacheable templates that can be customized by a consumer-facing application is described with reference to FIG. 2.

In one example, batch jobs (e.g., applications) are deployed on an application platform 200 (e.g., a hybrid cloud application platform, a cluster, etc.). As examples, the applications include a generative AI engine 202 and/or other applications 204. The applications used are based, in one example, on the event for which requests are being processed. In one example, generative AI engine 202 runs on a schedule to create 206 a variety of fill-in-the-blank templates and/or sentences that are used to provide customized replies.

To create the templates, in one example, a set of synthesized feature vectors relating to a selected event is generated to be inserted into a large language model. The large language model produces a variety of sentences that are post processed into templates. Each value to be customized is replaced by a token such that the sentence becomes a template. The templates are then stored into a dictionary-based structure (e.g., a dictionary-based JSON (JavaScript Object Notation) structure and/or other types of dictionary-based structures and/or other structures) that will have a prompt and value percentile key, when appropriate. As an example, the content (e.g., JSON content) is stored in a cloud object storage bucket 220 (and/or other cloud storage (e.g., cloud object storage 222, cloud 224, etc.) and fronted by one or more content delivery networks 230, 232 provided by one or more companies or entities. A content delivery network is, for instance, a group of servers (e.g., geographically distributed servers) that speed up the delivery of content (e.g., web content) by bringing it closer to the requesters (e.g., users or other requesters requesting information), As one example, a cloud service 242 (an example of an endpoint 240) is coupled to, at least, content delivery networks 230, 232 and used to distribute content across different locations 244a-244c.

A consumer-facing application that is deployed on a scaled out cluster platform (e.g., platform 200) will serve POST requests (e.g., application programming interface requests 250). An endpoint (e.g., endpoint 240) loads, based on the selected event, an in-memory cache containing the structure (e.g., JSON structure) from the content delivery network that has been produced by the batch job. In one example, the cache is within one or more content delivery networks, e.g., content delivery networks 230, 232. In other examples, the cache is located elsewhere. Many examples are possible.

At the time of a request, an application determines customized information and determines the type of prompts to be used to send to the large language model. However, instead of sending a request to the large language model, the prompt is used as a lookup key along with the percentile range of a particular value to retrieve a list of templates. The tokens in the template (e.g., template 255) are replaced by customized content (e.g., customized values) to construct, e.g., a fluent sentence. The sentences, which are based on the event and request, are placed into the returning payload to be rendered on the consumer-facing application.

In one or more aspects, the batched large language model architecture further includes an error analysis tool extension 260 used, in one or more aspects, to collect feedback of the requesters to be used, e.g., to update the large language model via, e.g., artificial intelligence 264, which is used to improve the populating of the templates.

In one example, to provide customized replies to requests, including a large number of requests, within a selected time frame, an artificial intelligence (AI) request/reply module (e.g., AI request/reply module 150) is used, in accordance with one or more aspects of the present disclosure. An AI request/reply module (e.g., AI request/reply module 150) includes code or instructions used to provide customized replies to requests, including a large number of requests, within a selected time frame, in accordance with one or more aspects of the present disclosure. An AI request/reply module (e.g., AI request/reply module 150) includes, in one example, various sub-modules to be used to create templates using one or more large language models trained and/or tuned to create the templates; select and retrieve one or more templates based on the requests from a selected location (e.g., cache); customize the one or more selected templates; and/or generate customized replies based on the customized template(s).

The sub-modules are, e.g., computer readable program code (e.g., instructions) in computer readable storage media, e.g., storage (persistent storage 113, storage 124, cache 121, other storage, as examples). The computer readable storage media may be part of a computer program product and the computer readable program code may be executed by and/or using one or more computing devices (e.g., one or more computers, such as computer(s) 101 and/or other computers, etc.; one or more end user devices, such as end user device(s) 103 and/or other end user devices, etc.; one or more servers, such as server(s) 104 and/or other servers, etc.; one or more processors or nodes, such as processor(s) or node(s) of processor set 110 and/or other processor sets, etc.; processing circuitry, such as processing circuitry of processor set 110 and/or other processor sets, etc.; and/or other computing devices, etc.). Additional and/or other computers, servers, devices, processors, nodes, processing circuitry and/or other computing devices may be used to execute one or more of the sub-modules and/or portions thereof. Many examples are possible.

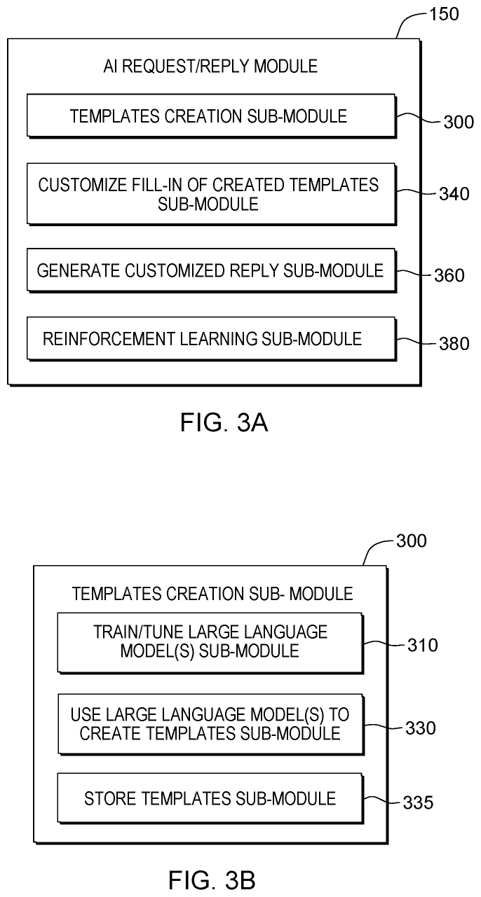

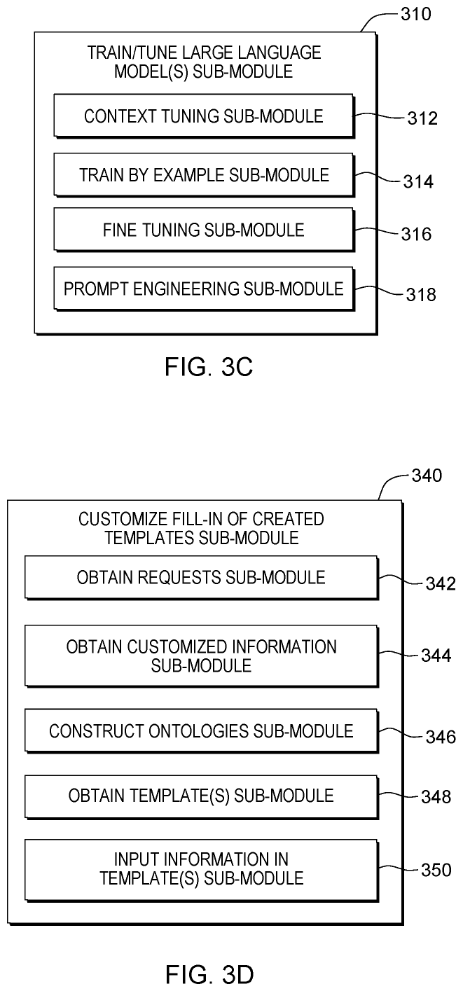

One example of AI request/reply module 150 is described with reference to FIGS. 3A-3D. In one example, referring to FIG. 3A, an AI request/reply module 150 includes, for instance, a templates creation sub-module 300 to create templates to be used to reply to requests; a customize fill-in of created templates sub-module 340 to populate (e.g., input into, fill-in, etc.) one or more selected templates to provide customized replies; a generate customized reply sub-module 360 to generate customized replies; and a reinforcement learning sub-module 380 to perform reinforcement learning of the one or more large language models used to create the templates. Although various sub-modules are described, an AI request/reply module, such as AI request/reply module 150, may include additional, fewer and/or different sub-modules. A particular sub-module may include additional code, including code of other sub-modules, less code, and/or different code. Further, additional and/or other modules and/or sub-modules may be used to create templates, provide customized replies and/or perform other aspects of the present disclosure. Many variations are possible.

Further details relating to templates creation sub-module 300 are described with reference to FIG. 3B. In one example, templates creation sub-module 300 includes a train/tune large language model(s) sub-module 310 to train and/or tune one or more large language models to be used to create one or more templates (e.g., artificial intelligence templates) to be used to provide customized replies; a use large language model(s) to create templates sub-module 330 to create the one or more templates using one or more trained and/or tuned large language models; and a store templates sub-module 335 to store the one or more created templates in a selected location (e.g., cache) accessible to one or more applications requesting customized replies (e.g., consumer-facing applications). Although various sub-modules are described, a templates creation sub-module, such as templates creation sub-module 300, may include additional, fewer and/or different sub-modules. A particular sub-module may include additional code, including code of other sub-modules, less code, and/or different code. Further, additional and/or other modules and/or sub-modules may be used to create templates and/or perform/provide other aspects of the present disclosure. Many variations are possible.

In one example, train/tune large language model(s) sub-module 310 includes a plurality of sub-modules further described with reference to FIG. 3C. In one example, train/tune large language model(s) sub-module 310 includes a context tuning sub-module 312, a train by example sub-module 314, a fine tuning sub-module 316 and a prompt engineering sub-module 318, one or more of which are used in training/tuning one or more large language models to be able to create templates to be used for selected events. Although various sub-modules are described, a train/tune large language model(s) sub-module, such as train/tune large language model(s) sub-module 310, may include additional, fewer and/or different sub-modules. A particular sub-module may include additional code, including code of other sub-modules, less code, and/or different code. Further, additional and/or other modules and/or sub-modules may be used to train/tune large language models and/or perform/provide other aspects of the present disclosure. Many variations are possible.

Further details relating to customize fill-in of created templates sub-module 340 are described with reference to FIG. 3D. In one example, customize fill-in of created templates sub-module 340 includes an obtain requests sub-module 342 to obtain requests for which customized replies are to be provided; an obtain customized information sub-module 344 to obtain customized information relating to the requester(s) and/or selected event for which information is being requested; a construct ontologies sub-module 346 to construct one or more ontologies about the domain (e.g., selected event); an obtain template(s) sub-module 348 to select and retrieve from the selected location one or more templates to be used to provide customized replies; and an input information in template(s) sub-module 350 to input at least a part of the information relating to the requester obtained from the one or more requester data sources corresponding to the request in one or more templates. Although various sub-modules are described, a customize fill-in of created templates sub-module, such as customize fill-in of created templates sub-module 340, may include additional, fewer and/or different sub-modules. A particular sub-module may include additional code, including code of other sub-modules, less code, and/or different code. Further, additional and/or other modules and/or sub-modules may be used to customize the fill-in of created templates and/or perform/provide other aspects of the present disclosure. Many variations are possible.

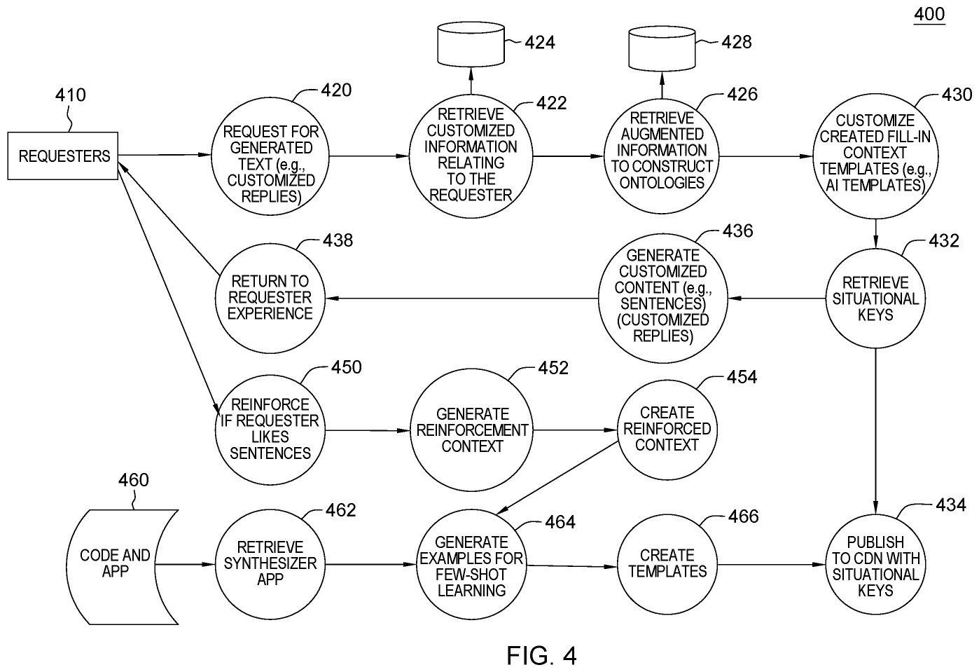

The sub-modules are used, in accordance with one or more aspects of the present disclosure, in executing a request/reply process (e.g., an artificial intelligence (AI) request/reply process), an example of which is described with reference to FIG. 4. In one example, a request/reply process 400 is executed by one or more computing devices (e.g., one or more computers, such as computer(s) 101 and/or other computers, etc.; one or more end user devices, such as end user device(s) 103 and/or other end user devices, etc.; one or more servers, such as server(s) 104 and/or other servers, etc.; one or more processors or nodes, such as processor(s) or node(s) of processor set 110 and/or other processor sets, etc.; processing circuitry, such as processing circuitry of processor set 110 and/or other processor sets, etc.; and/or other computing devices, etc.). Additional and/or other computers, servers, devices, processors, nodes, processing circuitry and/or other computing devices may be used to execute the request/reply process. Many examples are possible.

Referring to FIG. 4, in one example, request/reply process 400 (also referred to herein as process 400) is bifurcated into two parts: one part (e.g., stemming from requesters 410) relates to receiving requests from requesters, generating customized replies to the requests, providing the customized replies to the requesters, and optionally, receiving feedback from the requesters and re-performing training/tuning, based on the feedback, of one or more models (e.g., large language models) used in generating the customized replies; and another part (stemming from code and app 460) relates to training/tuning one or more large language models based on a selected event to create one or more templates for the selected event to be used in generating the customized replies. By bifurcating the request/reply process, the large language model(s) that are trained/tuned and used to create the templates are shielded from the requests enabling the large language model(s) to be trained/tuned and to generate the templates with a reduced set of computing resources than if they were not shielded from the requests.

In one example, request/reply process 400 receives 420 one or more requests for generated text (e.g., request(s) for customized replies) from one or more requesters 410 (e.g., over one or more networks of the computing environment). In one example, there are many requesters, even millions of requesters. Based on receiving the one or more requests, process 400 obtains information relating to the requester(s) from one or more requester data sources corresponding to the request. For instance, process 400 retrieves 422 information (also referred to as customized information) relating to the one or more requesters from, e.g., one or more repositories 424, such as one or more databases and/or other repositories. The information may relate to a requester's role with respect to the selected event, types of information being requested, preferences of the requester(s), etc. For example, the information may include an indication of what the requester is looking for (e.g., for a sporting event—positions, specific players, etc.), a time frame for the analysis, etc. Many examples are possible. The information depends on the type of requester and/or the type of event. The information is obtained, in one example, based on an opt-in process that enables the requesters to provide information and/or have information derived regarding the requesters. In one example, if a requester does not opt-in, then the information relating to the requesters is not obtained.

Further, in one example, process 400 retrieves 426 augmented information from one or more external data sources (e.g., repositories 428, such as one or more databases and/or other repositories). The augmented information is, for instance, retrieved based on queries of one or more external data sources regarding a domain. The domain is, in one example, the selected event. Based on the retrieved augmented information, one or more ontologies are constructed about the domain. An ontology is, for instance, a set of concepts and categories in a subject area or domain (e.g., selected event) that shows their properties and the relations between them. As an example, one or more external data sources are queried to construct one or more ontologies for the one or more domains associated with a request for a customized reply.

Based on the retrieved information (e.g., customized information relating to the requester(s) and the augmented information), process 400 customizes 430 one or more created fill-in context templates, as described in further detail herein. In one example, process 400 retrieves one or more templates (e.g., artificial intelligence templates) published 434 to one or more content delivery networks (CDNs) using one or more situation keys 432. For instance, a content delivery network cache is queried to retrieve one or more templates stored in a selected location (e.g., a content delivery network cache) based, at least in part, on at least one ontology of the one or more ontologies for the one or more domains associated with the requests for customized replies. In one example, a key (also referred to as a situation key) is used in retrieving the one or more templates. For instance, a key (e.g., situation key) associates a template with raw data such that a key function can generate a key (e.g., an identical key) to lookup a corresponding template. In one example, the key is generated based on a prompt of the request to select for retrieval at least one or more templates stored in the selected location.

Process 400 populates 430 the selected templates with, for example, selected customized information that is obtained (e.g., retrieval 422). For instance, process 400 inputs at least part of the information relating to the requester(s) obtained from the one or more requester data sources corresponding to the request to provide one or more populated templates. As described herein, in one example, this information includes an indication of what the requester is looking for (e.g., for a sporting event—positions, specific players, etc.), a time frame for the analysis, etc. The information depends on the type of requester and/or the type of event and may include various types of information.

Based on customizing the created fill-in templates by populating the one or more selected templates, process 400 generates 436 customized content (e.g., sentences) as customized replies to the requester. Process 400 provides (e.g., returns) 438 the customized replies to the requester(s) 410.

In one example, process 400 obtains 450 from one or more requesters information (e.g., requester feedback) relating to the returned customized replies, such as whether the returned customized replies are acceptable to the requesters. Based on the obtained information, process 400 generates 452 reinforcement context (e.g., an indication of what the requester likes, dislikes, etc., regarding the returned replies) and creates 454 reinforced context (an indication of modifications to be made), which is input to generating 464 and/or modifying examples for few-shot learning. For example, if the customized reply returned is regarding a player of a sport and indicates that a particular statistic of the player is “abysmal,” a requester may indicate that the term “abysmal” is too negative, and therefore, a modification is made to, e.g., a few shot to change “abysmal” to a less negative term. Many other examples are possible.

Further, in one example (e.g., for the other part of the bifurcated process), process 400 retrieves 462 a synthesizer app from code and app inputs 460 and performs training/tuning of one or more large language models. As part of the training process, in one example, process 400 generates 464 examples for few-shot learning, which are used in training/re-training/tuning one or more large language models, as described further below. Based on the training/re-training/tuning of one or more large language models, process 400 creates 466 one or more templates that are related to the selected event.

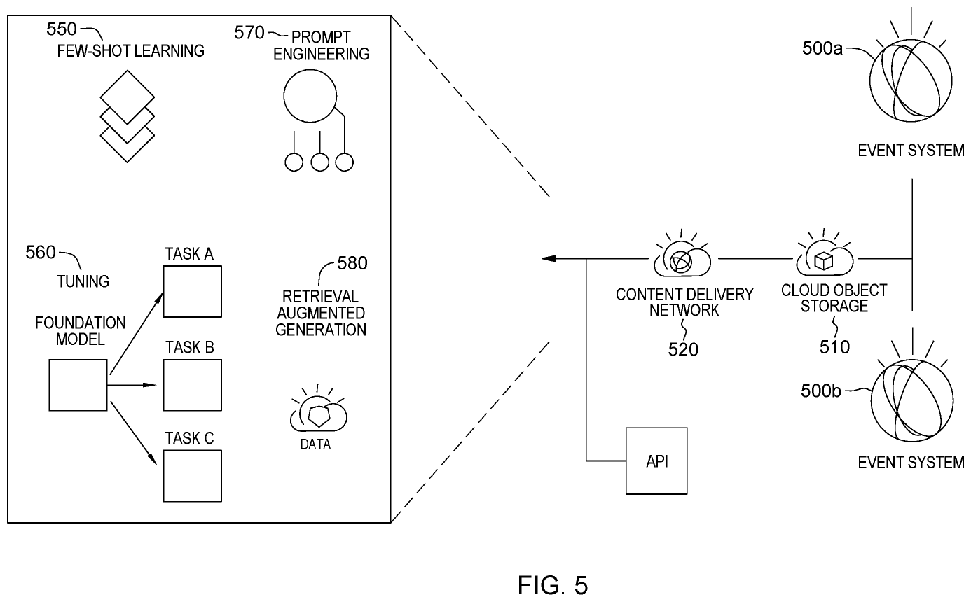

To create and/or modify templates, in one example, one or more large language models are trained/re-trained/tuned and hosted on an AI and data platform. A large language model is a foundational model for the creation of templates (also referred to as intermediary generative elements). During training/re-training/tuning, a large language model learns variables called parameters, which define the behavior of the model. There are different types of training and tuning of large language models, examples of which are described with reference to FIG. 5.

In one example, a selected large language model (e.g., a particular large language model of a selected size) is trained and tuned for a specific type of event. For instance, as depicted in FIG. 5, information from one or more event systems 500a, 500b is saved, for instance, in cloud object storage 510 and delivered for training and/or tuning of a large language model via, e.g., a content delivery network 520.

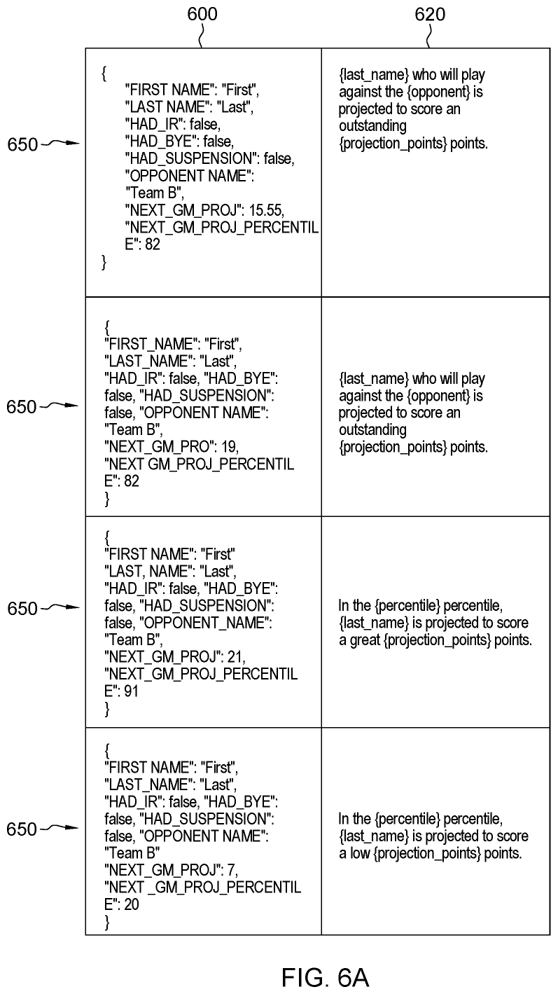

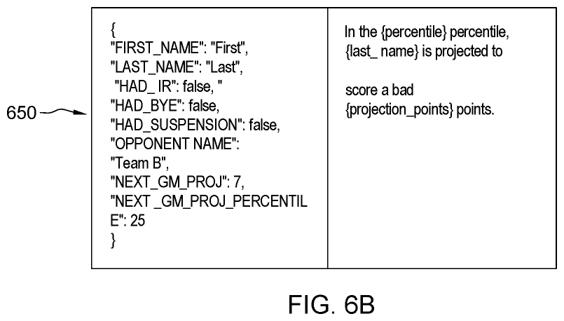

The training/re-training/tuning may include one or more of few-shot learning 550, tuning 560, prompt engineering 570 and retrieval augmented generation 580, each of which is further described herein. In one example, few-shot learning 550 is an example of a training by example technique, which is a technique to augment the model input with contextual (also referred to as context) vectors. Training by example techniques are used to make predictions based on a limited number of samples. It is a machine learning paradigm where a model is trained to make accurate predictions with a small number of examples per class. With few-shot learning, examples of input and output pairs show the model how to translate a request to a response. Within a selected event, a variety of examples are provided to a large language model to promote the learning of a variety of cases. In combination, a high temperature and sampling are parameterized to support a high variance of output. Example training pairs are depicted in FIGS. 6A-6B and exemplify how the model is to produce output sentences.

In the examples in FIGS. 6A-6B, the selected event is a physical activity event, such as football in, e.g., a virtual football league or a non-virtual football league, and the requests are related to players' statistics. Example inputs 600 are in the left column of FIGS. 6A-6B and suggested outputs 620 are in the right column. Each input/output pair 650 has an input 600 and an output 620.

With few-shot learning, the model can quickly learn the appropriate mapping between input and output. The following input with the few-shot learning examples depicted in FIGS. 6A-6B produces, e.g., “{last_name} who will play against the {opponent} is projected to score a low {projection points} points.”.
{
   “FIRST_NAME”: “First”,
   “LAST_NAME”: “Last”,
   “HAD_IR”: false,
   “HAD_BYE”: false,
   “HAD_SUSPENSION”: false,
   “OPPONENT_NAME”: “Team B”,
   “NEXT_GM_PROJ”: 4,
   “NEXT_GM_PROJ_PERCENTILE”: 10,
   }

Returning to FIG. 5, few-shot learning may be complemented by one or more tuning techniques 560. One such tuning technique is fine-tuning, a type of large language model domain adaptation, that may be performed for a selected event. Fine-tuning is a technique that can create a specialist around a specific domain (e.g., the selected event). In this way, training exemplars are input into a model with batches that define when the error of the output of the model as contrasted to the ground truth is back-propagated backwards to adjust activation function gradients. This technique runs over several epochs until a predefined threshold of an objective function is met such as perplexity or before overfitting occurs. Overfitting can be detected when the training error becomes smaller than the validation error. Fine tuning may be very computationally expensive when the trainable network size is in the billions. However, techniques, such as Parameter Efficient Fine Tuning (PEFT) and Low Rank Adaptation (LoRA), reduce the number of trainable parameters to as much as, e.g., 5-10% or less.

Jointly, prompt tuning, another type of tuning 560, combines the teaching of instruction sets and exemplars. The combination of these techniques enables the system to learn a specific area within a domain (e.g., of a selected event) and a new instruction set. Now the large language model can retain the generalization capabilities of other instructions while becoming a specialist around specific tasks.

The following depicts one example of a process of creating prompt tuning examples. The training data for the prompt tuning of a selected large language model is, for instance, within a selected format (e.g., the JSONL (JSON Lines) format). The format enables JSON new line delimited records for streaming processing. In one example, each line of the JSONL data is, e.g., in the form of:

{“instruction”: “Create a list item about next game projection”, “input”: “some text or JSON”, “output”: “generated fill in the blanks list items”}

The instruction enables prompt tuning with a specific input and output pair. A custom formatting prompts function is written, in one example, for each JSONL line to convert the data into training samples.
def formatting_prompts_func(examples):
   output_text=[ ]
   for i in range(len(examples)):
      instruction=examples[i][“instruction”]
      input_text=examples[i][“input”]
      response=examples[i][“output”]
      text=f′”
         ### Instruction:
         {instruction}
         ### Input:
         {input_text}
         ### Response:
         {response}
         . . . .
   return output_text

The training and infer data is pulled, for instance, from a content delivery network that contains relevant information for the selected event (e.g., football player valuation data).

The content of a minimized JSON file is used, in one example, as the input value. An example of a full JSON file is shown below.
{
“PLAYERID”: “XXXXXX”,
“FIRST_NAME”: “First”,
“LAST_NAME”: “Last”,
“EVENT_NAME”: “Event1”,
“EVENT_YEAR”: “2023”,
“PERCENTAGE_OWNED”: 0.9989986239388708,
“POSITION_RANK”: 5,
“BINNED_RANK”: 8,
“VALUATION”: 16.989297640252627,
“DECIMAL_GRADE”: 91.3372968985264,
“DATA_TIMESTAMP”: “2023 Sep. 8 00:00:00.000000”,
“EXECUTION_TIMESTAMP”: “2023 Sep. 8 00:00:00.000000”,
“HAD_IR”: false,
“HAD_BYE”: false,
“HAD_SUSPENSION”: false,
“IS_FREE_AGENT”: false,
“PRO_TEAM_ID”: 5,
“PRO_TEAM_NAME”: “Team X”,
“POSID”: 2,
“INJURY_STATUS”: “healthy”,
“NEXT_GAME_TIMESTAMP”: “2023 Sep. 10 17:00:00.000000”,
“OPPONENT_NAME”: “Team B”,
“OPPONENT_ID”: “4”,
“OWNERSHIP_PERCENTAGE_CHANGE”: 0.000445737529298782,
“SEASON_LONG_PROJECTION_VALUATION”: 0.9956905898024372,
“SCORING_PERIOD”: 1,
“COMPUTING_TYPE”: “combined”,
“SEASON_LONG_PROJECTION”: 254.4,
“TOTAL_GAMES”: 17,
“TOTAL_GAMES_LEFT”: 16,
“SEASON_ACTUAL”: 0,
“ON_IR”: false,
“ON_SUSPENSION”: false,
“TO_IGNORE”: false,
“VALUATION_OWNERSHIP_INDEX”: 1.9994443614681696,
“VALUATION_PREVIOUS_YEAR”: null,
“PERCENTAGE_STARTED”: 0.9931190900229222,
“NEXT_GM_PROJ”: 15.547166361000002,
“REST_SEASONPROJ”: 238.949792152,
“SUM_PROJ”: 15.547166361000002,
“MAX_PROJ”: 15.547166361000002,
“MIN_PROJ”: 15.547166361000002,
“SUM_ACT”: 0,
“MAX_ACT”: 0,
“MIN_ACT”: 0,
“PRESEASON_PROJECTION”: 281.40000000000003,
“AVG_DRAFT_POSITION”: 14.239660410097532,
“PENALTY”: 0,
“RANK_TOTAL”: 15
   }

An example derived JSON that is focused on the prompt of creating a list item about projections is shown below.
{
   “FIRST_NAME”: “First”,
   “LAST_NAME”: “Last”,
   “HAD_IR”: false,
   “HAD_BYE”: false,
   “HAD_SUSPENSION”: false,
   “OPPONENT_NAME”: “Team B”,
   “NEXT_GM_PROJ”: 15.55,
   “NEXT_GM_PROJ_PERCENTILE”: 82,
}

An example output is:
{last_name} who will play against the {opponent_name} is projected to score an outstanding {projection} points.

Further, returning to FIG. 5, in one or more aspects, prompt engineering 570 is used to ask the right questions(s) to obtain the best output from a large language model. It enables direct interaction with the large language model using plain language prompts (e.g., exclusively). Providing an instruction or a prompt to a large language model indicates the type of task to perform. This is used, for instance, to weight activation paths through the neural networks so that the most relevant type of information is retrieved. To synthesize, for instance, the top contributing factors of, e.g., a player's grade, specific prompts are used for the selected large language model to generate list items such as, for example:
1. Create a list item about improving a team's position
2. Create a list item about position need
3. Create a list item about health
4. Create a list item about next game projection
5. Create a list item about season projection
6. Create a list item about player grade
7. Create a list item about valuation
8. Create a list item about preseason projection
9. Create a list item about position rank
10. Create a list item about ownership change
11. Create a list item about started
12. Create a list item about draft position
13. Create a list item about league ownership
14. Create a list item about sentiment

Additional, fewer and/or other list items may be created. Further, the list items are based on the selected event, and therefore, other selected events will have other list items. Many examples are possible.

Moreover, still referring to FIG. 5, a technique called retrieval augmented generation (RAG) 580 establishes a context vector that provides supporting evidence or information for the creation of responses of prompts. In one example, the most timely and relevant data is retrieved from external data stores of which the large language model does not have the knowledge. Both non-parametric data from retrieval augmented generation is combined with the parametric information that was encoded by the large language model. In one example, the non-parametric data includes, e.g., current articles, documents, etc. of a player, and the parametric data includes the foundational model's weights and potentially any fine-tuned weight adjustments. The weights are used to, e.g., translate the player information to a high dimensional vector understandable by the large language model. An example retrieval augmented generation document could have the latest player's articles summarized by a feature vector to influence the structure and form of the output list items. Many other examples are possible and are based, for instance, on the selected event.

Thus, in one example, retrieval augmented generation is performed to establish one or more context vectors that provide supporting information for the generation of a customized reply to a request. To establish the one or more context vectors, selected data from one or more external data sources is retrieved. The selected data is knowledge data to be used to generate the customized reply. It is knowledge data missing from the large language model used to create one or more templates used to create the customized reply. The selected data that is retrieved is combined with parametric data encoded by the large language model to establish the one or more context vectors.

Each output from the model is, for instance, post processed into fill-in-the-blank list items or templates. For example, the following sentence is created by a large language model, in accordance with one or more aspects:

“{player_first_name} who will play against the {opponent_name} is projected to score an outstanding {next_game_projection} points.”

The tokens are transformed and substituted by customized values within the context of a selected event, such as football, and in one particular example, a football team manager (e.g., a requester) of a virtual football league.

In one example, each of the templates is stored within cloud object storage and fronted by a content delivery network. As an example, the JSON format of the storage is indexed by prompt type and percentile threshold, if desired. The prompt type enables the consumer-facing application (e.g., request/reply process 400) to find the collection of templates associated with a prompt. The percentile range allows the correct semantic type of template to be found.

For example, the following template is stored as below:
{
“Create a list item about next game projection”: {
“100-80”: [
“{player_first_name} who will play against the {opponent_name} is projected to score an outstanding {next_game_projection} points.”
   ]
}
   }

On the consumer-facing application, the algorithm decides the factors that contribute to a selected event (e.g., a player's grade and the percentile of the value relating to football). The factor is translated into a prompt and joined with the percentile to lookup possible list items. A single element from the array of list items is randomly selected. Each token in the template is replaced by customized values according to the selected event (e.g., football team manager's roster, team, and player grades, etc.).

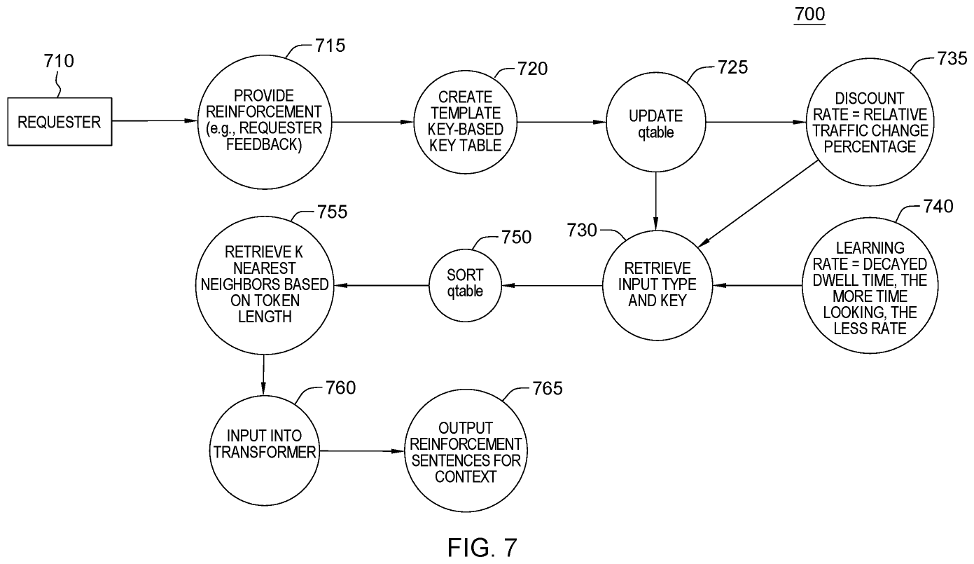

In one or more aspects, reinforcement learning is employed to align the large language model's actions with selected choices (e.g., human choices and/or AI generated choices). One example of reinforcement learning is described with reference to FIG. 7. In one example, a reinforcement learning process 700 is implemented using one or more of the sub-modules (e.g., sub-module 380) and is executed by one or more computing devices (e.g., one or more computers, such as computer(s) 101 and/or other computers, etc.; one or more end user devices, such as end user device(s) 103 and/or other end user devices, etc.; one or more servers, such as server(s) 104 and/or other servers, etc.; one or more processors or nodes, such as processor(s) or node(s) of processor set 110 and/or other processor sets, etc.; processing circuitry, such as processing circuitry of processor set 110 and/or other processor sets, etc.; and/or other computing devices, etc.). Additional and/or other computers, servers, devices, processors, nodes, processing circuitry and/or other computing devices may be used to execute the reinforcement learning process. Many examples are possible.

Referring to FIG. 7, in one example, reinforcement learning process 700 (also referred to as process 700) obtains reinforcement input 715 (e.g., requester feedback) relating to the received customized replies from a requester 710. Based on the reinforcement input, process 700 creates 720 a template key-based key table and updates 725 a qtable assigned to a selected key. A qtable represents, for instance, what is to change for, e.g., few shot learning and/or other tuning to satisfy the requester's requirements. In one example, a new Q value that maps states and actions is created based on the following equation:

New Q(s,a)=Q(s,a)+α[R(s,a)+γ max Q′(s′,a′)−Q(s,a)], where
New Q is the new Q value for that state and the action;
α is the learning rate;
R(s, a) is the reward for taking that action at that state;
Q(s, a) are the current Q values;
maxQ′(s′, a′) is the maximum expected future reward given the new state (s′) and all possible actions at that state; and
γ is the discount rate.

Process 700 retrieves 730 an input type and key. Input to retrieval 730 is, for example, a discount rate 735 and a learning rate 740. Discount rate 735 is, for instance, equal to a relative traffic change percentage and learning rate 740 is equal to a decayed dwell time—the more time looking, the less the rate.

Process 700 sorts 750 the qtable (e.g., by Q values in descending order, in which the largest Q values are first). In one example, the Q values are weights of the templates, and based on performing reinforcement learning context generation, one or more of the weights are modified based on the requester feedback.

Process 700 retrieves 755 the k nearest neighbors based on the token length, and inputs 760 the nearest neighbors into a transformer and outputs 765 reinforcement sentences or templates for context. The updated templates are then used, in one or more examples, to generate customized replies.

In one or more aspects, as described herein, templates created using one or more large language models are used to generate customized replies to requests related to selected events. Large language models are a type of machine learning models. Large language models use a type of machine learning called deep learning. Machine learning, including deep learning, may be used to train/retrain and/or tune large language models, perform predictive modeling, perform optimization modeling, learn from previous data/events, and/or perform other tasks. A system is trained to perform analyses and learn from input data and/or choices made.

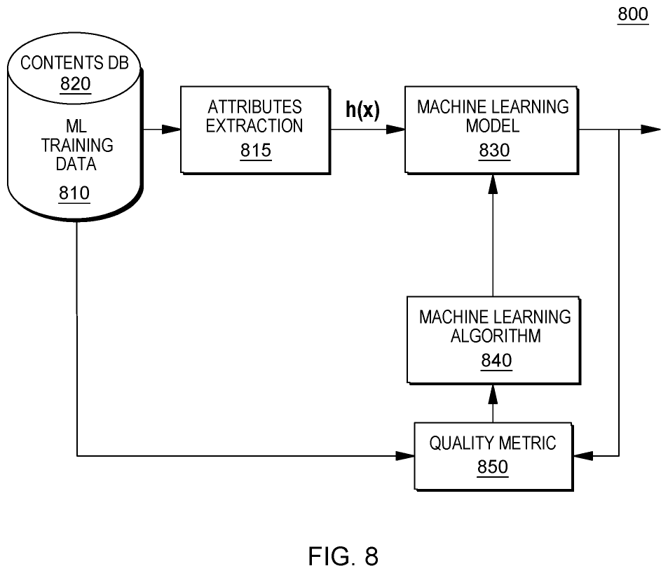

Referring to FIG. 8, in one or more aspects, a machine learning training system 800 may be utilized to perform cognitive analyses of various inputs, including data from one or more sources, data repositories and/or other data and/or perform training/retraining and/or tuning of large language models, as examples. Training data utilized to train a model (e.g., a training model, a large language model, etc.) in one or more embodiments of the present disclosure includes, for instance, data obtained from exogenous sources, data relating to a selected event, etc. The program code in embodiments of the present disclosure performs a cognitive analysis to generate one or more training data structures, including algorithms utilized by the program code to predict states of a given occurrence. Machine learning solves problems that are not solved with numerical means alone. In this machine learning-based example, program code extracts various attributes from machine learning training data 810 (e.g., historical data collected from various data sources relevant to the selected event, exogenous data, other data, etc.), which may be resident in one or more databases 820 comprising selected event data, given occurrence and/or task-related data and general data. Attributes 815 are utilized to develop a predictor function, h(x), also referred to as a hypothesis, which the program code utilizes as a machine learning model 830.

In identifying various states, features, attribute similarities, constraints and/or behaviors indicative of states in the machine learning training data 810, the program code can utilize various techniques to identify attributes in an embodiment of the present disclosure. Embodiments of the present disclosure may utilize varying techniques to select attributes (data attributes, elements, patterns, features, constraints, etc.), including but not limited to, diffusion mapping, principal component analysis, recursive feature elimination (a brute force approach to selecting attributes), and/or a Random Forest, to select the attributes related to various selected events and/or given occurrences. The program code may utilize a machine learning algorithm 840 to train the machine learning model 830 (e.g., training model, a large language model, etc.), including providing weights for the conclusions, so that the program code can train the predictor functions that comprise the machine learning model 830. The conclusions may be evaluated by a quality metric 850. By selecting a diverse set of machine learning training data 810, the program code trains the machine learning model 830 to identify and weight various attributes (e.g., data attributes, selected event attributes, features, patterns, constraints, etc.) that correlate to various states of an event and/or given occurrence.

The machine learning model generated by the program code is self-learning as the program code updates the machine learning model based on active event feedback, as well as from the feedback received from data related to the selected event and/or given occurrence, exogenous data, etc. For example, when the program code determines that there is a condition that was not previously predicted by the machine learning model, the program code utilizes a learning agent to update the machine learning model to reflect the state of the condition, in order to improve predictions in the future. Additionally, when the program code determines that a prediction is incorrect, either based on receiving user feedback through an interface or based on monitoring related to the selected event and/or given occurrence, the program code updates the machine learning model to reflect the inaccuracy of the prediction for the given period of time. Program code comprising a learning agent cognitively analyzes the data deviating from the modeled expectations and adjusts the machine learning model to increase the accuracy of the machine learning model, moving forward.

In one or more embodiments, program code executing on one or more computing devices utilizes an existing cognitive analysis tool or agent (now known or later developed) to tune the machine learning model, based on, e.g., data obtained from one or more data sources. In one or more embodiments, the program code interfaces with application programming interfaces to perform a cognitive analysis of obtained data. Specifically, in one or more embodiments, certain application programming interfaces comprise a cognitive agent (e.g., learning agent) that includes one or more programs, including, but not limited to, natural language classifiers, a retrieve and rank service that can surface the most relevant information from a collection of documents, concepts/visual insights, trade off analytics, document conversion, and/or relationship extraction. In an embodiment, one or more programs analyze the data obtained by the program code across various sources utilizing one or more of a natural language classifier, retrieve and rank application programming interfaces, and trade off analytics application programming interfaces. An application programming interface can also provide audio related application programming interface services, in the event that the collected data includes audio, which can be utilized by the program code, including but not limited to natural language processing, text to speech capabilities, and/or translation.

In one or more embodiments, deep learning (a subset of machine learning, which is an aspect of artificial intelligence) includes a set of techniques for learning in neural networks. Neural networks, including modular neural networks, are capable of pattern recognition with speed, accuracy, and efficiency, in situations where data sets are multiple and expansive, including across a distributed network, including but not limited to, cloud computing systems. Modern neural networks are non-linear statistical data modeling tools or decision making tools. They are usually used to model complex relationships between inputs and outputs or to identify patterns (or similarities) in data. In general, program code utilizing neural networks and/or other artificial intelligence techniques can model complex relationships between inputs and outputs and identify patterns in data. Because of the speed and efficiency of neural networks and/or other artificial intelligence techniques, especially when parsing multiple complex data sets, neural networks, other artificial intelligence techniques and deep learning provide solutions to many problems in multiple source processing. Such deep learning is used, in one or more aspects, in training/retraining/tuning, e.g., large language models used in creating templates used to generate customized replies, as described herein.

One or more aspects of the present disclosure are tied to computer technology and facilitate processing within a computing device, improving performance thereof. For instance, processing within the computing environment is improved by significantly reducing the amount of computing resources used to train the large language models used to create templates used to generate customized replies to requests. In one or more aspects, templates are created and stored for use in generating customized replies to requests. By creating and storing the templates, requests (including thousands of requests) received at a particular request rate (e.g., per second or other time period) are able to receive customized replies within a predefined amount of time (e.g., selected time period). In one or more aspects, the templates (e.g., artificial intelligence templates) are created using large language models and stored in a selected location (e.g., cache) making them accessible, scalable and usable to generate customized replies.

Although various capabilities of a request/reply process are described herein, in other embodiments, a request/reply process may include additional, fewer and/or other capabilities. The capabilities described herein are just examples.

In one particular example of one or more aspects of the present disclosure, the selected event is related to football of a virtual football league or a non-virtual football league, and, in one example, to requesters (e.g., team managers, other users, etc.) requesting customized (e.g., personalized) replies (e.g., player information and/or predictions) to requests related to the selected event. Further details regarding such a selected event are described below.

As described, large language models are used to create text and/or may be combined with diffusion models and/or generative adversarial networks to produce multimedia content. Large language models have been created to interpret sport scenes (and/or other selected events). For instance, at a golf tournament, a set of transformers converted statistics to text and then paraphrased the text for variety. In one example, 20,000 golf shots were commentated at the tournament. As another example, within tennis, 100,000 tennis scenes were processed by a selected model to convert statistics to sentences. In both golf and tennis, the text was translated from text to speech. However, both of these systems around large language models were limited in scale hovering around, e.g., 10 requests per second. Industry will be applying large language models within consumer-facing applications. Today, large language models are shielded with rate limiters and/or supported by large numbers of graphics processing unit based machines.

The application of generative AI techniques within very high web traffic, as defined as, e.g., more than 100 requests per second, is limited within industry. In one example, a football player insights widget supporting application programming interfaces serves an extremely high amount of traffic. In a best case scenario, a typical graphics processing unit with 32 GB can provide inference response times of, e.g., 1 second and take, e.g., hours to train. To sustain, e.g., a 1-3 seconds response time for the football application, the inference system would need, e.g., 834 parallel graphics processing units. Further, the amount of graphics processing unit memory used to load and train large language models is related to the model parameter size. To train a model at 7 billion parameters with bf16 (brain floating point 16), 70 GB is used, in one example. Optimization techniques such as Parameter Efficient Fine Tuning (PEFT) and Low Rank Adaptation (LoRA) can reduce the training memory used to, e.g., 7 GB of memory. During inference, as one example, 1.4 GB of memory is used to load, e.g., 1B parameters, which translates to almost, e.g., 10 GB of memory used. As the large language model parameter set increases to, e.g., 70 B, the amount of memory to load the model grows to, e.g., 98 GB. Thus, an approach is devised, in one or more aspects, to provide football consumers of, e.g., a virtual football league with a generative AI experience.

In one example, leading up to the first week of a football season, the football widget supporting application programming interfaces are serving upwards of, e.g., 3,000 requests per second. Over time, the traffic decreases to an estimated 2,000 requests per second, as an example, as caching and application programming interface call optimizations are re-implemented. The low traffic periods or traffic troughs will settle to an estimated 300 requests per second, as one example. The high demand time periods will occur between a particular time period incurring the most significant traffic. Contributing factors to the supporting football widget application programming interfaces include:
Over 650 football player grading including all rostered and waiver wire players.
Customization of all player grades on the football widget that incurs more than 8 billion interactions over a season.
Customized trade analysis between two teams with over 20 million views over a season.

The cloud infrastructure that hosts the football widget application programming interfaces is spread over multiple (e.g., 3) sites and horizontally scaled (see, e.g., FIG. 2). Traffic is balanced across the multiple sites (e.g., using a traffic manager now known or later developed) and entered into a selected container platform cluster. Each of the clusters has, e.g., 150 pods for a total of 450 pods across the multiple sites. Each cluster includes, for instance, two ingress nodes with four CPU's and 16 GB of RAM (random access memory). In one example, the pods are evenly spread out on worker nodes with, e.g., 16 CPU's and 32 GB RAM. In one example, each site may handle upwards of, e.g., 2,500 requests per second.

To provide a generative AI experience, in one or more aspects of the present disclosure, the following are provided: creation of intermediary generative elements (also referred to as templates) that can be customized by a consumer-facing application; interlacing of smaller models with context tuning based on model functional magnetic resonance imaging (fMRI's)—Isolate the parts of a large model that are selected and prune the rest out; reinforcement learning context generation for the output of intermediary generative elements from large language models; the hybrid approach of combination of reinforcement learning and retrieval augmented generation achieves highly efficient and scalable systems where both can be customized and tailored such as updating the vector database as well as reward functions. Iteratively, the customizations gathered with this approach may be implemented as fine tuning in the prospective releases.

One example of a process flow of millions of requesters (an example of which is users) wanting to create customized large language output is depicted in FIG. 4. The users request a customized response at, e.g., a rate of 2,000 requests per second (or other request rate). The consumer-facing application retrieves information about the user (e.g., based on consent). Next, external data sources are queried to construct an ontology about the domain. The consumer-facing application queries a content delivery network cache to retrieve artificial intelligence generated templates.

Further, in one example, a batch application runs in the background and on a schedule. The application retrieves a synthesizer application. The synthesizer application produces examples of transforming data into templates. This piece of information becomes the examples for few-shot learning. A reinforced context piece is generated based on the user's feedback about the returned sentences (i.e., the customized replies). The context helps the large language models to weight the type of template to return. The templates are created, for instance, with few-shot learning and context learning. A key associates the output template with the raw data such that a key function can generate a key (e.g., an identical key) to lookup a corresponding template.

Customized data is used to fill in generative AI based templates. The finalized sentence (e.g., customized reply) is returned to the user. The user can inform the system what they do or do not like through reinforcement learning.

In one example, players' information cards are used to assist football team managers (e.g., requesters) make decisions about which players on their roster to start, acquire from an opponent's roster or pickup from the waiver wire, as an example. In one or more aspects, a generative AI capability is provided that describes why a team manager should make a roster move. The evidence based generative AI reasoning will be displayed on the player's information card. The generative text is customized for each team manager's team and league. With over, e.g., 11 million users within, e.g., a virtual football league, the demand on the consumer-facing application programming interfaces that generate the customized text will have a peak of over, e.g., 3,000 requests per second (or other request rate). As a result of the high usage of the information cards in combination with a fast response time of under, e.g., 4 seconds (or other amount of time), a generative AI approach is designed and implemented.

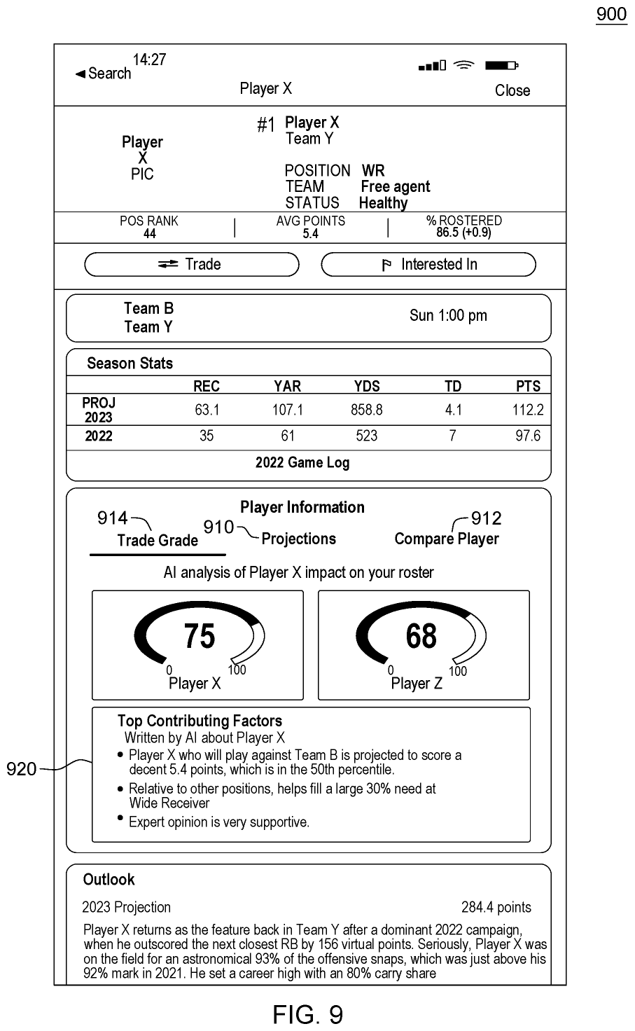

In one example, a player's card has three possible tabs as depicted in one example in FIG. 9 that show information (e.g., insights) about the player. For instance, a card 900 has a Projections tab or section 910 that presents boom and bust potential along with score projections and trends, and a Compare Player tab or section 912 that enables a team manager to contrast multiple player performances. Further, in one example, card 900 includes another tab or section that is conditional. For instance, if the player is on an opposing team's roster, the tab becomes a Trade Grade section or tab 914 that depicts the player's grade within the context of a trade. Alternatively, if the selected player is on the waiver wire, the tab changes to, e.g., a Waiver Grade section or tab to show the player's grade relative to a player pickup. For each tab or section, templates are used to create contributing factors (e.g., top 3) that contribute towards a player's grade. In one or more aspects, the templates are generated using artificial intelligence. For instance, for Player X, a list of contributing factors 920 produced using templates generated using artificial intelligence include, e.g.:
Player X who will play against Team B is projected to score a decent 5.4 points, which is in the 50^{th} percentile.
Relative to other positions, helps fill a larger 30% need at Wide Receiver.
Expert opinion is very supportive.

The list items that display, e.g., the contributing factors towards a player's grade, are composed and written by artificial intelligence, in one or more aspects.

An example of an architecture that shields the large language models from direct consumer traffic by teaching the model how to compose templates that are retrievable by the consuming-facing application is depicted in FIG. 2 and described herein.

Batch jobs are deployed on an application platform (e.g., a hybrid cloud application platform), as denoted, in one example, at the upper left of the architecture diagram. An application titled “Generative AI Engine” runs on a schedule to generate or create a variety of fill in-the-blank sentences or templates that provide the basis for the top contributing factors that contribute to a player's grade. A set of synthesized feature vectors about players and prompts are generated to be inserted into a large language model. The large language model produces a variety of sentences that are post processed into templates. Each value that is customized is replaced by a token such that the sentence becomes a template. The templates are then stored, for instance, into a dictionary-based JSON structure that has a prompt and value percentile key, when appropriate. The JSON content is stored within a cloud object storage bucket and fronted by a content delivery network.

A consumer-facing application that is deployed on a scaled out cluster platform serves POST requests. An “all player” grades endpoint, as an example, loads an in-memory cache containing the JSON structure from the content delivery network that is produced by the batch job. At the time of a request, a selected application determines the customized player grades and determines the type of prompts to send to the large language model. However, instead of sending a request to the large language model, the prompt is used as a lookup key along with the percentile range of a particular value to retrieve a list of templates. The tokens in the template are replaced by customized values to construct a fluent sentence. The top contributing factor sentences are placed into the returning payload to be rendered on the consumer-facing experience.

In one or more aspects, for a generative artificial intelligence training technique, a large language model is trained and hosted on an AI and data platform and is the foundational model for the generative AI components within the application widget. Techniques, such as few-shot learning, prompt tuning, prompt engineering, and retrieval augmented generation, transform the large language model into, e.g., a football player grade expert. External data from selected external sources, trusted sources on the Internet, and other data will be utilized for the creation of a generative artificial intelligence experience. FIG. 5 depicts one example of an overall model adaptation flow.

Several different types of training and tuning of large language models support the player's generative artificial intelligence top contributing sentences. For example, training by example is a technique to augment the model input with contextual vectors. The techniques within the state of the art include, e.g., one-shot and few-shot training. Examples of input and output pairs show the model how to translate a request to a response. Within a virtual football league, as an example, a variety of examples are provided to a large language model to promote the learning of a variety of cases. In combination, a high temperature and sampling are parameterized to support a high variance of output. Example training pairs that exemplify how the model should produce output sentences are depicted in FIGS. 6A-6B.

With the few-shot learning, the model can quickly learn the appropriate mapping between input and output. The following input with the above few-shot learning produces “{last_name} who will play against the {opponent} is projected to score a low {projection_points} points.”.
{
   “FIRST_NAME”: “First”,
   “LAST_NAME”: “Last”,
   “HAD_IR”: false,
   “HAD_BYE”: false,
   “HAD_SUSPENSION”: false,
   “OPPONENT_NAME”: “Team B”,
   “NEXT_GM_PROJ”: 4,
   “NEXT_GM_PROJ_PERCENTILE”: 10,
   }

Another type of large language model domain adaptation is referred to as fine-tuning. In this way, training exemplars are input into a model with batches that define when the error of the output of the model as contrasted to the ground truth is back-propagated backwards to adjust activation function gradients. This technique runs over several epochs until a predefined threshold of an objective function is met such as perplexity or before overfitting occurs. Overfitting can be detected when the training error becomes smaller than the validation error. Fine tuning can be very computationally expensive when the trainable network size is in the billions. However, techniques such as Parameter Efficient Fine Tuning (PEFT) and Low Rank Adaptation (LoRA) reduce the number of trainable parameters to as much as, e.g., 5-10% or less.

The technique of fine-tuning for the players widget can complement few-shot learning. Fine-tuning is a technique that can create a specialist around a specific domain. Jointly, prompt tuning combines the teaching of instruction sets and exemplars. The combination of these techniques enables the system to learn a specific area within a domain and a new instruction set. Now the large language model can retain the generalization capabilities of other instructions while becoming a specialist around specific tasks.

The following depicts one example of the process of creating prompt tuning examples. The training data for the prompt tuning of the selected large language model is within the JSONL format, as one example. The format enables JSON new line delimited records for streaming processing. Each line of the JSONL data is of the form, e.g.:
{“instruction”: “Create a list item about next game projection”, “input”: “some text or JSON”, “output”: “generated fill in the blanks list items”}

The instruction enables prompt tuning with a specific input and output pair. A custom formatting prompts function is written for each JSONL line to convert the data into training samples.
def formatting_prompts_func(examples):
   output_text=[ ]
   for i in range(len(examples)):
      instruction=examples[i][“instruction”]
      input_text=examples[i][“input”]
      response=examples[i][“output”]
      text=f′”
         ### Instruction:
         {instruction}
         ### Input:
         {input_text}
         ### Response:
         {response}
         . . . .
   return output_text

The training and infer data are pulled from, e.g., the selected content delivery network that contains, e.g., virtual football league football player valuation data.

The content of a minimized JSON file is used, in one example, as the input value.

An example of a full JSON file is shown below.
{
“PLAYERID”: “XXXXXXX”,
“FIRST_NAME”: “First”,
“LAST_NAME”: “Last”,
“EVENT_NAME”: “Event1”,
“EVENT_YEAR”: “2023”,
“PERCENTAGE_OWNED”: 0.9989986239388708,
“POSITION_RANK”: 5,
“BINNED_RANK”: 8,
“VALUATION”: 16.989297640252627,
“DECIMAL_GRADE”: 91.3372968985264,
“DATA_TIMESTAMP”: “2023 Sep. 8 00:00:00.000000”,
“EXECUTION_TIMESTAMP”: “2023 Sep. 8 00:00:00.000000”,
“HAD_IR”: false,
“HAD_BYE”: false,
“HAD_SUSPENSION”: false,
“IS_FREE_AGENT”: false,
“PRO_TEAM_ID”: 5,
“PRO_TEAM_NAME”: “Team X”,
“POSID”: 2,
“INJURY_STATUS”: “healthy”,
“NEXT_GAME_TIMESTAMP”: “2023 Sep. 10 17:00:00.000000”,
“OPPONENT_NAME”: “Team B”,
“OPPONENT_ID”: “4”,
“OWNERSHIP_PERCENTAGE_CHANGE”: 0.000445737529298782,
“SEASON_LONG_PROJECTION_VALUATION”: 0.9956905898024372,
“SCORING_PERIOD”: 1,
“COMPUTING_TYPE”: “combined”,
“SEASON_LONG_PROJECTION”: 254.4,
“TOTAL_GAMES”: 17,
“TOTAL_GAMES_LEFT”: 16,
“SEASON_ACTUAL”: 0,
“ON_IR”: false,
“ON_SUSPENSION”: false,
“TO_IGNORE”: false,
“VALUATION_OWNERSHIP_INDEX”: 1.9994443614681696,
“VALUATION_PREVIOUS_YEAR”: null,
“PERCENTAGE_STARTED”: 0.9931190900229222,
“NEXT_GM_PROJ”: 15.547166361000002,
“REST_SEASONPROJ”: 238.949792152,
“SUM_PROJ”: 15.547166361000002,
“MAX_PROJ”: 15.547166361000002,
“MIN_PROJ”: 15.547166361000002,
“SUM_ACT”: 0,
“MAX_ACT”: 0,
“MIN_ACT”: 0,
“PRESEASON_PROJECTION”: 281.40000000000003,
“AVG_DRAFT_POSITION”: 14.239660410097532,
“PENALTY”: 0,
“RANK_TOTAL”: 15
   }

An example derived JSON that is focused on the prompt of creating a list item about projections is shown below.
{
   “FIRST_NAME”: “First”,
   “LAST_NAME”: “Last”,
   “HAD_IR”: false,
   “HAD_BYE”: false,
   “HAD_SUSPENSION”: false,
   “OPPONENT_NAME”: “Team B”,
   “NEXT_GM_PROJ”: 15.55,
   “NEXT_GM_PROJ_PERCENTILE”: 82,
}

An example output is:

{last_name} who will play against the {opponent_name} is projected to score an outstanding {projection} points.

Providing an instruction or a prompt to a large language model indicates the type of task to perform. This is used to weight activation paths through the neural networks so that the most relevant type of information is retrieved. To synthesize the top contributing factors of a player's grade, specific prompts are used for the selected large language model to generate list items such as:
1. Create a list item about improving a team's position
2. Create a list item about position need
3. Create a list item about health
4. Create a list item about next game projection
5. Create a list item about season projection
6. Create a list item about player grade
7. Create a list item about valuation
8. Create a list item about preseason projection
9. Create a list item about position rank
10. Create a list item about ownership change
11. Create a list item about started
12. Create a list item about draft position
13. Create a list item about league ownership
14. Create a list item about sentiment

A technique called retrieval augmented generation establishes a context vector that provides supporting evidence or information for the creation of responses of prompts. In one example, the most timely and relevant data is retrieved from external data stores of which the large language model does not have the knowledge. The non-parametric data from the retrieval augmented generation is combined with the parametric information that was encoded by the large language model. The parametric data includes both the foundational model's weights and any potentially fine-tuned weight adjustments. An example retrieval augmented generation document may have, for instance, the latest player's articles summarized by a feature vector to influence the structure and form of the output list items.

Each of the output from the model is post processed into fill-in-the-blank list items or templates. For example, the following sentence is created by a large language model:
“{player_first_name} who will play against the {opponent_name} is projected to score an outstanding {next_game_projection} points.”

The tokens are transformed and substituted by customized values within the context of the virtual football league team manager.

Each of the templates is stored within a selected cloud object storage and fronted by a content delivery network. In one example, the JSON format of the storage is indexed by prompt type and percentile threshold, if desired. The prompt type enables the consumer-facing application to find the collection of templates associated with a prompt. The percentile range will allow the correct semantic type of template to be found.

For example, the following template is stored as below:
{
“Create a list item about next game projection”: {
“100-80”: [
“{player_first_name} who will play against the {opponent_name} is projected to score an outstanding {next_game_projection} points.”
   ]
}
   }

On the consumer-facing application, the algorithm decides the factors to be selected (e.g., based on importance) that contribute to a player's grade and the percentile of the value. The factor is translated into a prompt and joined with the percentile to lookup possible list items. A single element from the array of list items is randomly selected, in one example. Each token in the template is replaced by customized values according to the virtual football league team manager's roster, team, and player grades, as examples.

One or more aspects of the present disclosure include a computer-implemented method, computer system and computer program product for customized (e.g., personalized) large language model (LLM) output, including receiving user requests for customized responses at a particular user request rate per second; retrieving, from a consumer-facing application, user information from respective user data sources corresponding to the user requests; querying external data sources to construct ontologies for domains associated with the user requests for customized responses; querying a content delivery network (CDN) cache to retrieve artificial intelligence (AI) templates based, at least in part, on the ontologies for the domains associated with the user requests for customized information; inputting the user information from the user data sources into the AI templates; and generating the customized responses to the user requests based on the user information input into the AI templates.

In one embodiment, the computer-implemented method, computer system and computer program product further include receiving user feedback regarding the customized responses to the user requests; and assigning respective weights to the artificial intelligence templates based on the user feedback regarding the customized responses, wherein the respective weights are assigned based on performing reinforcement learning context generation.

In one embodiment, the computer-implemented method, computer system and computer program product further include performing retrieval augmented generation (RAG) to establish context vectors that provide supporting evidence or information for the creation of the customized responses to the user requests, wherein the context vectors are established based on: retrieving the most timely and relevant data from the external data stores for which the large language model is missing the requisite knowledge to return a customized response to a user request; and combining non-parametric data from the retrieval augmented generation with parametric data (foundational model weights and fine-tuned weight adjustments) encoded by the large language model.

In one embodiment, the artificial intelligence templates are updated using few-shot learning and context learning.

In one embodiment, the computer-implemented method, computer system and computer program product further include interlacing small language models with context tuning based on functional magnetic resonance imaging of the large language model in order to isolate respective parts of the large language model that are important and prune other parts from the large language model that are not important.

In one embodiment, the computer-implemented method, computer system and computer program product further include generating a key that associates an AI template with raw data such that a key function can generate an identical key to lookup a corresponding template.

In one or more aspects, templates are created using different parts of large language models and using retrieval augmented generation and reinforcement learning to modify the context information that goes into creating the templates.

Other aspects, variations and/or embodiments are possible.

One or more aspects of the present disclosure may be used with many types of environments. The computing environments provided herein are only examples. Each computing environment is capable of being configured to include one or more aspects of the present disclosure. For instance, each may be configured to create artificial intelligence templates, generate customized replies to requests using the created artificial intelligence templates and/or perform one or more other aspects of the present disclosure.

In addition to the above, one or more aspects may be provided, offered, deployed, managed, serviced, etc. by a service manager who offers management of customer environments. For instance, the service manager can create, maintain, support, etc. computer code and/or a computer infrastructure that performs one or more aspects for one or more customers. In return, the service manager may receive payment from the customer under a subscription and/or fee agreement, as examples. Additionally, or alternatively, the service manager may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. A variety of large language models and/or training/tuning techniques may be used. Various artificial intelligence architectures and/or computing architectures may be used. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating processing within a computing environment, the computer-implemented method comprising:
receiving from a requester a request for a customized reply, the receiving the request using one or more networks of the computing environment;
retrieving one or more templates stored in a selected location based, at least in part, on at least one ontology constructed for one or more domains associated with the request for the customized reply;
inputting into the one or more templates information relating to the requester to provide one or more populated templates;
generating the customized reply to the request based on the one or more populated templates; and
providing the customized reply to the requester.

2. The computer-implemented method of claim 1, wherein the one or more templates are one or more artificial intelligence templates.

3. The computer-implemented method of claim 1, wherein the one or more templates are created using a large language model that is tuned to isolate one or more chosen parts of the large language model and to prune one or more other parts from the large language model that are not chosen.

4. The computer-implemented method of claim 1, wherein the retrieving the one or more templates comprises:
using a key generated based on a prompt of the request to select for retrieval at least one template of the one or more templates stored in the selected location.

5. The computer-implemented method of claim 1, further comprising:
receiving requester feedback regarding the customized reply provided to the requester; and
modifying one or more weights of the one or more templates based on the requester feedback, wherein the one or more weights are modified based on performing reinforcement learning context generation.

6. The computer-implemented method of claim 1, further comprising:
performing retrieval augmented generation to establish one or more context vectors that provide supporting information for generation of the customized reply to the request; and
establishing the one or more context vectors, the establishing comprising:
retrieving selected data from one or more external data sources, the selected data being knowledge data missing from a large language model used to create the one or more templates, the knowledge data to be used to generate the customized reply; and
combining the selected data that is retrieved with parametric data encoded by the large language model to establish the one or more context vectors.

7. The computer-implemented method of claim 6, wherein the parametric data includes one or more large language model weights and one or more fine-tuned weight adjustments.

8. The computer-implemented method of claim 1, wherein the customized reply to the request is to be received within a predefined amount of time.

9. The computer-implemented method of claim 1, wherein the receiving the request comprises receiving a plurality of requests for a plurality of customized replies at a particular request rate, the plurality of requests including the request.

10. The computer-implemented method of claim 1, wherein the one or more templates are generated using a large language model, the large language model trained using a reduced set of computing resources.

11. A computer system for facilitating processing within a computing environment, the computer system comprising:
a processor set;
a set of at least one computer-readable storage medium; and
program instructions, collectively stored in the set of at least one computer-readable storage medium for causing the processor set to perform the following computer operations including:
receive from a requester a request for a customized reply, the receiving the request using one or more networks of the computing environment;
retrieve one or more templates stored in a selected location based, at least in part, on at least one ontology constructed for one or more domains associated with the request for the customized reply;
input into the one or more templates information relating to the requster to provide one or more populated templates;
generate the customized reply to the request based on the one or more populated templates; and
provide the customized reply to the requester.

12. The computer system of claim 11, wherein the one or more templates are created using a large language model that is tuned to isolate one or more chosen parts of the large language model and to prune one or more other parts from the large language model that are not chosen.

13. The computer system of claim 11, wherein the retrieving the one or more templates comprises:
using a key generated based on a prompt of the request to select for retrieval at least one template of the one or more templates stored in the selected location.

14. The computer system of claim 11, wherein the computer operations further comprise:
receiving requester feedback regarding the customized reply provided to the requester; and
modifying one or more weights of the one or more templates based on the requester feedback, wherein the one or more weights are modified based on performing reinforcement learning context generation.

15. The computer system of claim 11, wherein the receiving the request comprises receiving a plurality of requests for a plurality of customized replies at a particular request rate, the plurality of requests including the request.

16. A computer program product for facilitating processing within a computing environment, the computer program product comprising:
a set of at least one computer-readable storage medium; and
program instructions, collectively stored in the set of at least one computer-readable storage medium for causing a processor set to perform the following computer operations including:
receive from a requester a request for a customized reply, the receiving the request using one or more networks of the computing environment;
retrieve one or more templates stored in a selected location based, at least in part, on at least one ontology constructed for one or more domains associated with the request for the customized reply;
input into the one or more templates information relating to the requester to provide one or more populated templates;
generate the customized reply to the request based on the one or more populated templates; and
provide the customized reply to the requester.

17. The computer program product of claim 16, wherein the one or more templates are created using a large language model that is tuned to isolate one or more chosen parts of the large language model and to prune one or more other parts from the large language model that are not chosen.

18. The computer program product of claim 16, wherein the retrieving the one or more templates comprises:
using a key generated based on a prompt of the request to select for retrieval at least one template of the one or more templates stored in the selected location.

19. The computer program product of claim 16, wherein the computer operations further comprise:
receiving requester feedback regarding the customized reply provided to the requester; and
modifying one or more weights of the one or more templates based on the requester feedback, wherein the one or more weights are modified based on performing reinforcement learning context generation.

20. The computer program product of claim 16, wherein the receiving the request comprises receiving a plurality of requests for a plurality of customized replies at a particular request rate, the plurality of requests including the request.

21. A computer-implemented method of facilitating processing within a computing environment, the computer-implemented method comprising:
receiving from a requester a request over one or more networks of the computing environment, the request related to a selected event;
retrieving one or more templates stored in a selected location, the one or more templates retrieved based, at least in part, on one or more ontologies constructed for the selected event, the one or more templates created using a large language model trained to create the one or more templates based on the selected event, the large language model shielded from direct request traffic;
inputting information in the one or more templates to provide one or more populated templates;
generating a customized reply to the request based on the one or more populated templates; and
providing to the requester the customized reply that is generated based on the one or more populated templates.

22. The computer-implemented method of claim 21, wherein the providing the customized reply is performed within a selected amount of time.

23. The computer-implemented method of claim 21, wherein the large language model is trained using a reduced set of computing resources.

24. The computer-implemented method of claim 21, wherein the receiving the request comprises receiving a plurality of requests at a particular request rate, the plurality of requests including the request.

25. The computer-implemented method of claim 21, wherein the large language model that is trained is tuned using one or more tuning techniques.
